(19) United States
(12) Patent Application Publication
(10) Pub. No.: US 2026/0223077 A1
(43) Pub. Date: Jul. 30, 2026

(54) DYNAMIC RESOURCE ALLOCATION IN OPEN RADIO ACCESS NETWORKS

(71) Applicant: Cisco Technology, Inc., San Jose, CA (US)

(72) Inventors: Indermeet GANDHI, San Jose, CA (US); Humberto J. LA ROCHE, Ocean, NJ (US); Mark GRAYSON, Maidenhead (GB)

(21) Appl. No.: 19/036,494

(22) Filed: Jan. 24, 2025

(51) Int. Cl. H04W 72/04; H04W 28/08

(52) U.S. Cl. CPC H04W 72/04; H04W 28/0967

(57) ABSTRACT

In one embodiment, dynamic resource allocation in open radio access networks (O-RAN) is provided. An example process herein comprises: collecting telemetry data for one or more network slices across a plurality of carriers in an open radio access network; determining per-slice traffic demands of the one or more network slices from a cross-carrier aggregation of the telemetry data; allocating radio resources of the open radio access network for each of the one or more network slices across carriers to support the per-slice traffic demands; and configuring slice-specific parameters for enforcement in the open radio access network based on the radio resources allocated to each of the one or more network slices.

### TECHNICAL FIELD

The present disclosure relates generally to computer networks, and, more particularly, to dynamic resource allocation in open radio access networks (O-RAN).

### BACKGROUND

The Open Radio Access Network (O-RAN) is a new approach to building mobile networks, where, unlike traditional proprietary RAN architectures, O-RAN adopts an open, modular framework that allows for greater flexibility, interoperability, and scalability. At its core, O-RAN disaggregates the RAN into several functional components connected through open interfaces, enabling operators to mix and match hardware and software from different vendors. This promotes innovation and reduces costs.

The efficient and dynamic allocation of radio resources in shared O-RAN infrastructures, however, remains a challenge, particularly when addressing the demands of diverse vertical services and multi-tenant scenarios. Existing architectures lack the flexibility and intelligence to dynamically optimize resource allocation for heterogeneous services, while accommodating real-time traffic variations and ensuring cost-effective scalability.

In particular, the advancement of 5G services requires a new approach to resource allocation in O-RAN architectures. Operators face significant challenges in meeting the diverse requirements of vertical services such as enhanced Mobile Broadband (eMBB), massive Machine Type Communications (mMTC), and Ultra-Reliable Low-Latency Communications (URLLC). Traditional RAN architectures struggle to deliver the needed flexibility and efficiency for multi-tenant, shared RAN infrastructures. Building separate networks for each vertical is not economically or environmentally viable, and current shared RAN solutions lack the intelligence to dynamically adapt to traffic demands.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example open radio access network (O-RAN) system;

FIG. 4 illustrates an example mobile network (e.g., O-RAN) architecture from the management point of view;

FIG. 5 illustrates an example RAN slicing scenario;

FIG. 6 illustrates an example simplified procedure for dynamic resource allocation in O-RAN in accordance with the first specific implementation herein, namely focusing on the use of the RAN Intelligent Controller (RIC) for real-time optimization of resource allocation;

FIG. 7 illustrates an example simplified procedure for dynamic resource allocation in O-RAN in accordance with the second specific implementation herein, namely introducing the concept of distributed applications (dApps) running on the O-DU; and

FIG. 8 illustrates an example simplified procedure for dynamic resource allocation in O-RAN in accordance with one or more embodiments described herein, generally.

### DESCRIPTION OF EXAMPLE EMBODIMENTS

### Overview

According to one or more embodiments of the disclosure, dynamic resource allocation in open radio access networks (O-RAN) is provided. In one embodiment, an example process comprises: collecting telemetry data for one or more network slices across a plurality of carriers in an open radio access network; determining per-slice traffic demands of the one or more network slices from a cross-carrier aggregation of the telemetry data; allocating radio resources of the open radio access network for each of the one or more network slices across carriers to support the per-slice traffic demands; and configuring slice-specific parameters for enforcement in the open radio access network based on the radio resources allocated to each of the one or more network slices.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

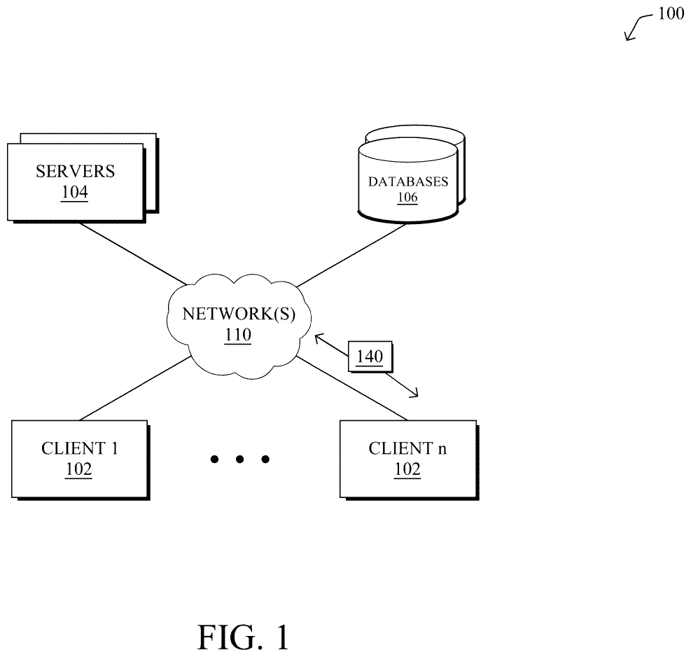

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

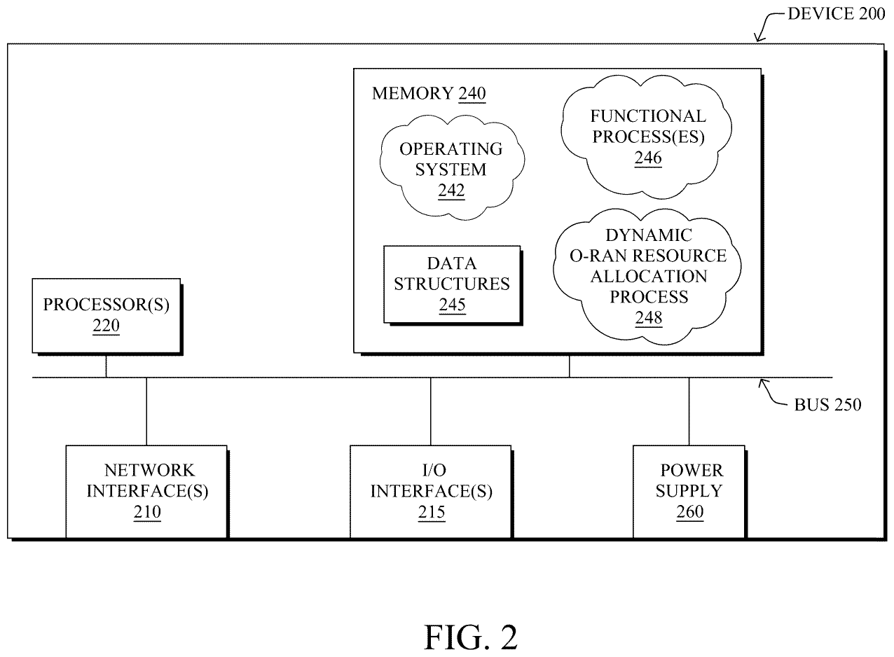

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a dynamic O-RAN resource allocation process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a controller would be configured to operate as a controller, a server would be configured to operate as a server, an access point (or gateway) would be configured to operate as an access point (or gateway), a client device would be configured to operate as a client device, and so on.

In various implementations, as detailed further below, one or more functional processes 246 and/or dynamic O-RAN resource allocation process (process 248) may include computer executable instructions that, when executed by processor(s) 220, cause device 200 to perform the techniques described herein. To do so, in some implementations, one or more functional processes 246 and/or process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, one or more functional processes 246 and/or process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that one or more functional processes 246 and/or process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, one or more functional processes 246 and/or process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, one or more functional processes 246 and/or process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, one or more functional processes 246 and/or process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Dynamic Resource Allocation in O-RAN

Cellular networks are the backbone of modern connectivity, enabling billions of devices worldwide to communicate with each other. At their core, cellular networks are systems of interconnected radio towers and base stations that provide wireless communication to mobile devices. These networks rely on a series of protocols and technologies to ensure reliable and efficient communication, from voice calls to high-speed internet access. Cellular networks are structured in layers, with the Radio Access Network (RAN) serving as the critical interface between user devices and the network core.

The evolution of cellular networks has been driven by the increasing demand for faster speeds, higher reliability, and the ability to support a growing variety of devices and services. Early networks, like 2G and 3G, focused primarily on voice communication and basic data transfer. With the advent of 4G, broadband internet access became a reality for mobile users, enabling high-speed data services like streaming and video calls. Currently, 5G is revolutionizing the landscape by promising ultra-reliable, low-latency communication, massive device connectivity, and enhanced mobile broadband speeds.

At the heart of this connectivity lies the Radio Access Network (RAN). The RAN is the part of the network that connects mobile devices to the core network using radio signals. It comprises base stations (such as macro towers and small cells) that communicate directly with user equipment like smartphones, tablets, and IoT devices. Traditional RAN architectures were built with proprietary hardware and software, often tied to a single vendor. While effective for simpler networks, this approach limits flexibility, scalability, and interoperability in a world demanding diverse services and increasing data traffic.

To address these challenges, the industry has moved toward Open Radio Access Networks (O-RAN). O-RAN is a new architectural framework that disaggregates traditional RAN components into modular elements with standardized open interfaces. This approach allows operators to mix and match components from different vendors, fostering innovation and reducing costs. O-RAN also incorporates advanced intelligence and automation, leveraging technologies like artificial intelligence and machine learning to optimize network performance dynamically.

The need for O-RAN arises from the complexity and diversity of modern network demands. Unlike earlier generations, 5G networks must support a wide array of use cases, including enhanced mobile broadband (eMBB) for high-speed internet, massive machine-type communication (mMTC) for IoT devices, and ultra-reliable low-latency communication (URLLC) for applications like autonomous vehicles and remote surgeries. Managing these diverse requirements across shared infrastructure requires protocols and frameworks like O-RAN, which provide the flexibility and intelligence needed to allocate resources efficiently and dynamically.

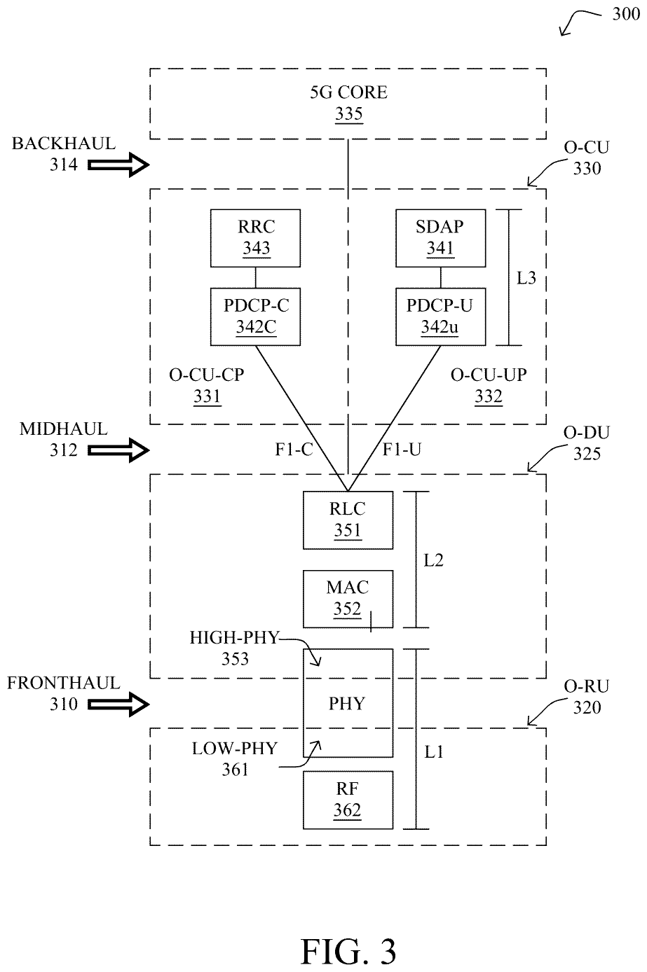

FIG. 3 illustrates an example O-RAN system 300, showcasing disaggregation and open interfaces that promote flexibility, scalability, and vendor interoperability, as noted above. In particular, the transport layers within the RAN include a fronthaul 310, a midhaul 312, and a backhaul 314. These layers/terms define the interfaces connecting different components of the network:
Fronthaul 310 connects the O-RU 320 (O-RAN Radio Unit) to the O-DU 325 (O-RAN Distributed Unit). Traditionally, this interface has been proprietary, relying on protocols like Common Public Radio Interface (CPRI) and enhanced CPRI (eCPRI). O-RAN aims to standardize and open this interface to ensure interoperability between vendors, creating an open eCPRI standard.
Midhaul 312 links the O-DU 325 to the O-CU 330 (O-RAN Central Unit). This interface is standardized by 3GPP and commonly referred to as the “F1” interface (shown divided into control “F1-C” and user “F1-U” interfaces). It facilitates communication between the digital processing units of the RAN.
Backhaul 314 is the connection between the O-CU 330 and the network core 335 (e.g., 5G as shown). This interface has traditionally been open and handles the flow of data between the RAN and the core network. In legacy networks, this would be the connection between the baseband unit (BBU) and the core.

Within O-RAN, the 5G New Radio (NR) protocol stack is divided among several key components, each handling specific layers of communication. First, the O-CU 330 (O-RAN Central Unit) manages the higher layers of the protocol stack, including:
Service Data Adaptation Protocol (SDAP) 341 maps Quality of Service (QoS) flows to data radio bearers and tags uplink/downlink packets with QoS flow IDs;
Packet Data Convergence Protocol (PDCP) (split into PDCP-C 342c and PDCP-U 342u) maps packet data units to logical channels and manages user/control data transmission; and
Radio Resource Control (RRC) 343 is responsible for managing connections, mobility, and system information broadcasts.
   Also, the O-CU 330 is further divided into i) the O-CU-CP (Control Plane) 331 to handle control-specific tasks like RRC and PDCP-C, and ii) the O-CU-UP (User Plane) 332 to manage user-specific data flows through SDAP and PDCP-U.

Second, the O-DU 325 (O-RAN Distributed Unit) hosts the lower layers of the protocol stack, including:
Radio Link Control (RLC) 351, which manages error correction through Automatic Repeat Requests (ARQ), sequence numbering, and upper-layer data transfer;
Media Access Control (MAC) 352, which maps transport and logical channels, performs multiplexing, and corrects errors using Hybrid ARQ (HARQ); and
High-PHY Layer 353, which handles upper-level physical processing, interfacing the MAC with the physical layer.

Third, the O-RU 320 (O-RAN Radio Unit) is responsible for the Low-PHY layer 361 and radio frequency (RF) processing 362, converting digital signals to analog for over-the-air transmission.

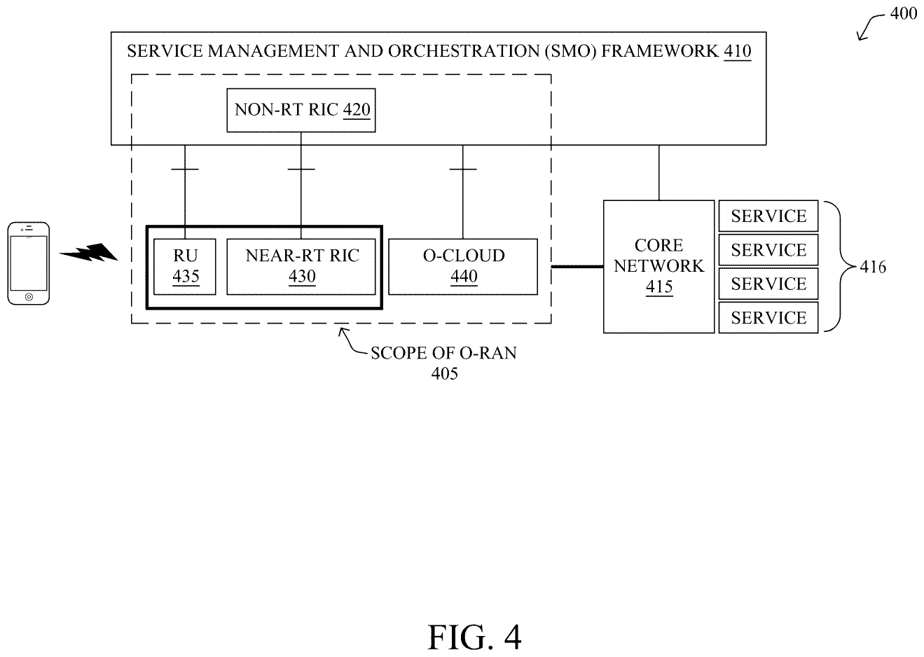

FIG. 4 illustrates a typical mobile network (O-RAN) architecture (architecture 400) from the management point of view. In particular, the Service Management and Orchestration (SMO) system and the RAN Intelligent Controllers (RICs) are key components of the O-RAN architecture, providing essential capabilities for managing, optimizing, and orchestrating the network.

The SMO framework 410 is the central management entity for the RAN domain. It oversees tasks such as configuration, performance monitoring, and lifecycle management of O-RAN functions 405. Beyond the RAN, the SMO integrates with other management domains like core network 415 (offering associated services 416), as well as transport and end-to-end slicing management, ensuring holistic control and coordination across the entire mobile network.

Within the SMO, the Non-Real-Time RAN Intelligent Controller (Non-RT RIC 420) plays a critical role in long-term optimization and policy management. Operating with latencies greater than one second, the Non-RT RIC drives high-level decisions. It comprises a framework and rApps (Non-RT RIC Applications), which use advanced analytics, AI, and machine learning to deliver insights and generate policy-based guidance for the RAN.

Complementing the Non-RT RIC, the Near-Real-Time RIC (Near-RT RIC 430) focuses on immediate control and optimization of RAN elements, such as RUs 435. Operating with control loops ranging from 10 milliseconds to one second, the Near-RT RIC enables fine-grained, responsive adjustments to network conditions. It collects detailed telemetry data and executes targeted actions to optimize resource allocation, traffic management, and overall network performance in real-time.

The O-RAN Cloud, or O-Cloud 440, provides the physical and virtual infrastructure needed to support these components. Defined by the O-RAN Alliance, the O-Cloud is a cloud computing platform built to meet the specific requirements of O-RAN. It hosts critical functions like the O-CU (Central Unit), O-DU (Distributed Unit), and other RAN components. The O-Cloud's open architecture ensures scalability, flexibility, and vendor interoperability. By enabling these functions to run in a virtualized and disaggregated manner, the O-Cloud supports the dynamic and efficient operation of the O-RAN system.

Notably, by disaggregating the network and opening these interfaces, O-RAN creates a modular ecosystem where operators can integrate components from different vendors. This architecture not only enhances flexibility and innovation but also enables intelligent automation through the use of RICs and standardized interfaces. These advancements are essential for meeting the diverse demands of modern 5G services, from enhanced mobile broadband to ultra-reliable low-latency applications.

That is, as noted above, traditional RAN architectures struggle to support the dense and heterogeneous deployments required for 5G services. Building parallel infrastructure for vertical use cases is costly, unsustainable, and does not leverage the promise of 5G technologies like network slicing across multiple services. O-RAN's flexibility, on the other hand, allows operators to customize these components and add new capabilities.

In general, network slicing is proposed as the way operators will tackle vertical use cases using their macro network and existing cell-site grid. However, traditional single-operator RAN architectures struggle to efficiently support dense heterogeneous deployments needed for 5G services. Building separate parallel infrastructure stacks for each vertical use case is prohibitively expensive for several reasons:
It is environmentally unsustainable as the number of base station sites grow 10-100×.
Managing multiple networks becomes enormously complex.
The resulting solution does not take advantage of the promise of 5G which is to leverage multiple service (mMTC, eMBB, URLLC) across multiple verticals.
   These factors are steering the industry towards fundamentally reimagining RAN sharing models.

O-RAN sharing has largely relied on the idea of a shared O-RU which while conceptually very attractive, has proved elusive in practical implementation owing to the difficulties of addressing versatile spectrum slicing requirements with mixed numerologies as required by vertical services.

Moreover, while O-RAN architectures allow RAN disaggregation and greater flexibility through open interfaces between components, current O-RAN specifications still lack flexible real-time radio resource control in multi-operator shared RAN scenarios. Different operators sharing the same O-RAN infrastructure are unable to optimize and tailor resource allocation dynamically based on per-tenant application demand.

The techniques herein, therefore, address these limitations by introducing a system that can dynamically optimize radio resource allocation in real-time, leveraging both centralized intelligence and tenant-level customizations. In particular, the techniques herein introduce an enhanced O-RAN-based system that enables dynamic, intelligent, and multi-tenant resource optimization for 5G networks. The solution leverages a programmable RAN Intelligent Controller (RIC) and/or distributed applications (dApps) operating on shared O-DU infrastructure to facilitate real-time, traffic-aware resource allocation across network slices, accommodating diverse verticals and tenant-specific requirements. The present disclosure thus bridges the gap between centralized control and tenant-specific customization, offering a scalable, efficient, and flexible framework for the future of 5G and beyond.

Specifically, according to one or more embodiments of the disclosure as described in detail below, an example process comprises: collecting telemetry data for one or more network slices across a plurality of carriers in an open radio access network; determining per-slice traffic demands of the one or more network slices from a cross-carrier aggregation of the telemetry data; allocating radio resources of the open radio access network for each of the one or more network slices across carriers to support the per-slice traffic demands; and configuring slice-specific parameters for enforcement in the open radio access network based on the radio resources allocated to each of the one or more network slices.

Operationally, the embodiments herein provide a multi-faceted framework for dynamic and intelligent resource optimization in O-RAN networks, combining RIC-based telemetry aggregation and/or dApp-enabled multi-tenant resource management.

As described in greater detail below, in one specific embodiment herein, a RAN Intelligent Controller (RIC) gathers PHY/MAC telemetry, including QoS metrics, buffer statuses, and traffic patterns. This data is processed by machine learning models to determine optimal resource allocation configurations, optimizing slicing and numerology allocation across aggregated carriers. The RIC communicates these configurations to the O-DU, where they are enforced through MAC scheduling. This ensures resource allocation aligns with the specific QoS requirements of each service type, dynamically adapting to traffic variations.

In another specific embodiment herein, customizable tenant-specific applications (e.g., dApps) execute on a shared O-DU to enable multi-tenant radio resource arbitration, allowing operators to analyze their traffic metrics and optimize resource allocation within their slices. Each tenant operator can deploy dApps tailored to their specific traffic

profiles, while a central arbitration application dynamically allocates physical resource blocks (PRBs) between tenants based on real-time demand. That is, the central arbitration application aggregates demand reports from all tenants and dynamically allocates PRBs based on real-time traffic conditions.

### Implementation 1: Shared O-DU and O-RU, With Near Real-time RIC

Instead of relying on a shared O-RU, this particular implementation relies on a shared RAN scheduler implementing Carrier Aggregation (“CA”) across multiple bands and supporting multiple numerologies. By addressing the slicing implementation in the O-DU (which contains the scheduler), the O-RAN operator can move to dynamically adjustable allocation of resources to each slice via the RIC.

To unlock the full benefits of O-RAN based network slicing, enhancements are needed for real time decision making to dynamically optimize allocation of radio resources in real time across slices addressing different verticals each of which can be shared or assigned to multiple tenants. This improves utilization efficiency of the radio resources by ensuring each slice tenants gets the resources it needs to attain stated service level agreement (SLA) objectives.

As such, this particular implementation of the present disclosure introduces an enhanced 5G architecture with a programmable RAN Intelligent Controller (RIC) for real time data driven optimization of network slicing and numerology allocation across aggregated carriers on a per-service basis. As described in greater detail below, the RIC interfaces with the O-CU and O-DU network functions to gather PHY/MAC layer telemetry across component carriers such as buffer status, QoS metrics, traffic burstiness patterns, etc. An intelligent RIC application (xApp) aggregates the telemetry data to determine per-slice resource demand across service classes for each carrier in real-time. It computes an optimal combination of numerologies across carriers to assign to each slice for the next scheduling interval, matching their observed traffic patterns and service requirements. The xApp configures MAC scheduling parameters for enforcing slice isolation and configures access control policies such as concurrency limits for each slice on a shared O-DU.

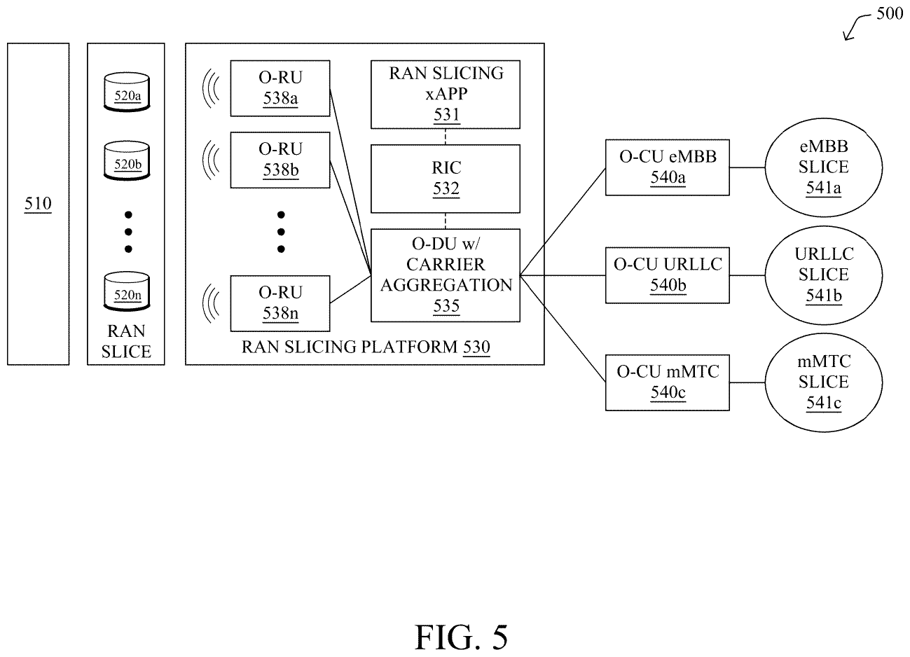

FIG. 5 illustrates an example RAN slicing scenario 500, where multiple vertical use cases 510 are shown on the left hand side, such as, e.g., smartphones, industrial automation, video games, virtual reality (VR) and/or augmented reality (AR), and so on. For each use case, and thus for each corresponding RAN slice 520a-n established by the RAN slicing xApp 531, the RIC 532 of the RAN slicing platform 530 allocates resources within the carrier aggregate to meet the SLA required for the slice. For instance, O-DU 535 with carrier aggregation would manage interfacing with each slice via an O-RU 538a-n according to the allocations, interfacing with corresponding O-CUs accordingly, such as O-CU eMBB 540a for eMBB slice 541a, O-CU URLLC 540b for URLLC slice 541b, and O-CU mMTC 540c for mMTC slice 541c, respectively. For example, an eMBB user would get more of 15 kHz and 30 kHz numerology and less of specialized low latency or mMTC resources. Conversely, the other users would receive a resource allocation from the RIC NS xApp to meet the service requirements.

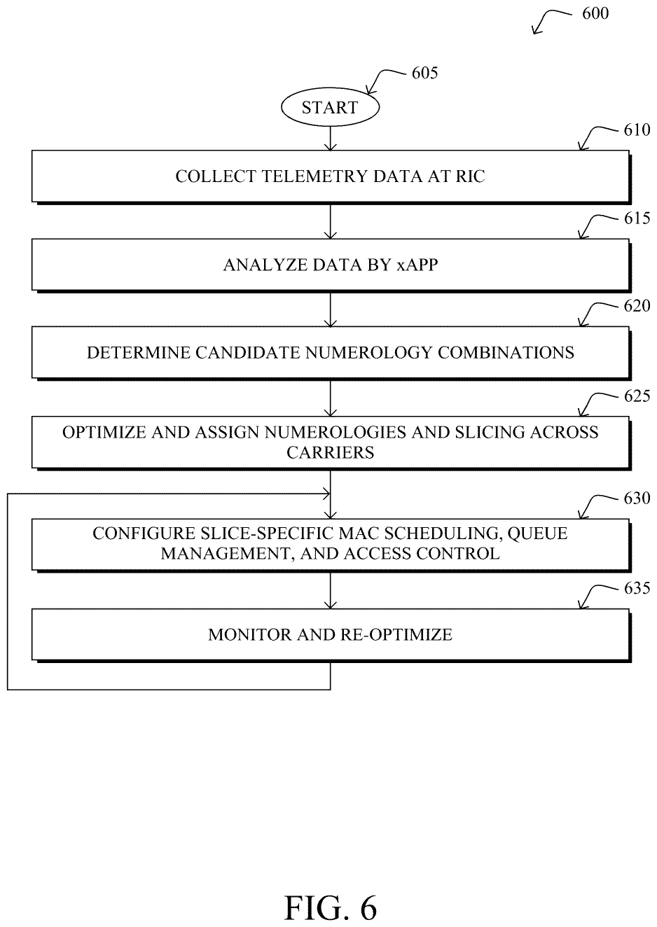

Operationally, FIG. 6 illustrates an example simplified procedure (procedure 600) for dynamic resource allocation in O-RAN in accordance with the first specific implementation herein, namely focusing on the use of the RAN Intelligent Controller (RIC) for real-time optimization of resource allocation. For example, a non-generic, specifically configured device (e.g., device 200, an apparatus) may perform procedure 600 by executing stored instructions (e.g., process 248). The procedure 600 may start at step 605, and continues to step 610, where the RIC collects real-time telemetry data, including traffic patterns and QoS metrics, from network components. Specifically, the RIC may gathers the following PHY/MAC layer telemetry across component carriers from the O-CU and O-DU:
Buffer status reports indicating queue occupancies;
QoS metrics such as packet delay, loss rates, jitter;
Traffic burstiness patterns and distributions;
Slice congestion and load status;
RF conditions and link adaptation parameters;
Etc.

In step 615, this data is cross-carrier analyzed. That is, the xApp may apply machine learning techniques to analyze the aggregated telemetry and model per-slice traffic characteristics across each carrier, including:
Packet inter-arrival time distributions;
Traffic variability and burstiness patterns;
Average and peak data rates;
Latency and reliability requirements;
Mobility patterns;
An so on.

Next, the techniques herein may compute optimal numerology configurations and slicing parameters, which are then enforced by the O-DU. Specifically, in step 620, the xApp may determine candidate numerology combinations across carriers for each slice that can support observed traffic characteristics. Numerology combinations may be selected from the set of up to four subcarrier spacings, e.g., as defined in 5G NR (e.g., currently 15 kHz to 240 kHz). Numerology selection addresses reduced latency (e.g., higher subcarrier spacing (SCS) supports reduced time transmission interval (TTI)). Then, in step 625, the xApp computes a network-wide optimization to assign numerologies and slicing across carriers to maximize QoS and business objectives for each slice, subject to policy constraints. Optimization techniques can include heuristic algorithms, reinforcement learning, and constraint programming.

In step 630, the xApp coordinates with the O-DU to enforce slice-specific MAC scheduling, queue management, and access control policies across carriers according to the optimized configuration.

In step 635, the techniques herein continuously monitor network conditions and re-optimizes slice configurations as needed. That is, the xApp may continuously monitor telemetry and may re-optimize slice configurations every scheduling interval (e.g., every 10 ms) to adapt to traffic variations.

The procedure may then return to step 630 to repeat steps 630 and 635 to dynamically adjust slicing and numerology allocation across component carriers as network conditions and service demands evolve. (Note that reinforcement learning and ML techniques can be used here, as may be appreciated by those skilled in the art.)

According to this particular implementation of the techniques herein, therefore, the following features may be evident within a system for dynamic slicing optimization in a 5G radio access network having a RAN Intelligent Controller (RIC) communicatively coupled to a plurality of transmission reception points (TRPs):
the RIC gathers PHY/MAC layer telemetry across a plurality of component carriers from the TRPs;
the RIC applies machine learning techniques to analyze the telemetry and model per-slice traffic characteristics across each component carrier;
the RIC computes an optimal combination of numerologies across component carriers to assign to each network slice based on modeled per-slice traffic characteristics and network policies;
the RIC generates slice configuration signaling including the optimized numerology and slicing allocation across component carriers for propagation to the TRPs;
the TRPs enforce the optimized slicing and numerology configuration across component carriers for each scheduling interval; and, therefore,
multiple operators can share the slicing and numerology configurations as tenants of a shared platform

### Implementation 2: dApps on Shared O-DU for Tenant Resource Sharing

Inflexible off-the-shelf hardware schedulers in shared O-Distributed Units (O-DUs) are not customizable per operator needs. Near-RT RIC xApps have only aggregated view of RAN, not per-slice demand. This hinders efficient sharing models where operators cannot adapt resources to traffic variations in their network slices.

As opposed to using the RIC as described above, this particular implementation uses distributed applications (dApps) running on O-DU (e.g., shared O-DU and O-RU, no RIC involved), i.e., RAN-based slicing via O-DUs. That is, the techniques herein according to this implementation propose using customizable distributed applications (dApps) hosted on shared O-DU alongside a multi-tenant radio resource arbitration application.

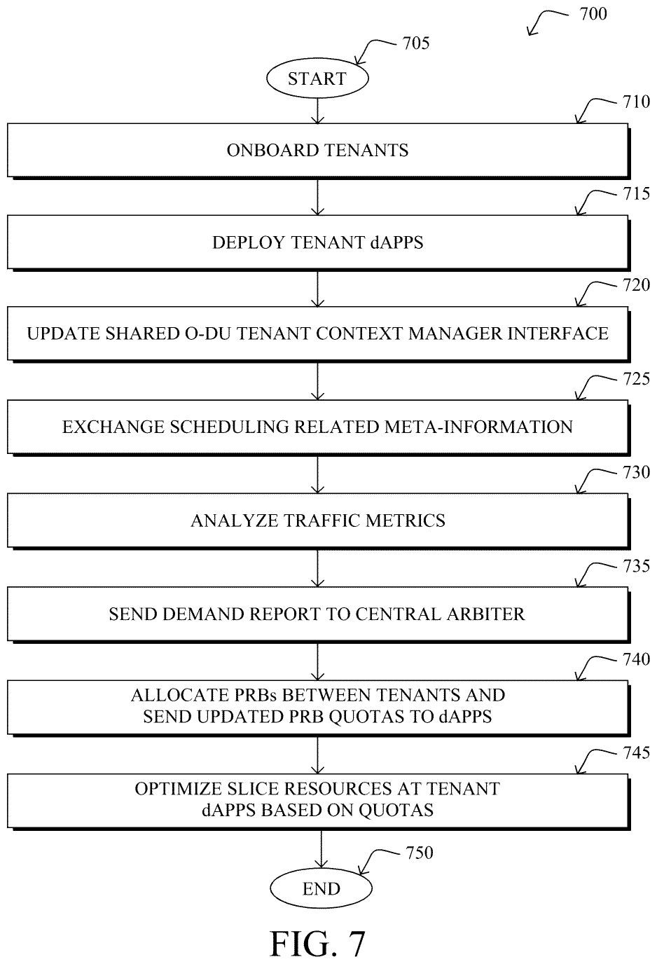

FIG. 7 illustrates an example simplified procedure (procedure 700) for dynamic resource allocation in O-RAN in accordance with the second specific implementation herein, namely introducing the concept of distributed applications (dApps) running on the O-DU. For example, a non-generic, specifically configured device (e.g., device 200, an apparatus) may perform procedure 700 by executing stored instructions (e.g., process 248). The procedure 700 may start at step 705, and continues to step 710, where, as described in greater detail above, tenant operators are onboarded onto the shared O-RAN infrastructure. During on-boarding of a new tenant operator onto the shared O-RAN infrastructure, in step 715, each tenant deploys dApps tailored to their traffic profiles. Specifically, in one embodiment herein, the O-Cloud resource orchestrator instantiates a dedicated virtualized application hosting environment for that tenant with infrastructural resources like CPU, memory, storage. A default quota of accelerators (such as GPU, NIC, FPGA) may also be allocated upfront to the tenant environment for efficient dApp execution. Standard container technology (e.g., Docker®/Kubernetes®) may be leveraged for portable dApp deployment.

In step 720, the tenant context manager interface on the shared O-DU is updated with mapping of newly created hosting environment to the tenant ID (e.g., using O1 management plane signaling, as will be appreciated by those skilled in the art). This allows tenant isolation and access control across pre-allocated resources.

In step 725, scheduling related meta-information is exchanged between the dApp and the shared operator's O-Cloud. In one embodiment, this includes network slice profiles that are installed as part of service profiles on the O-DU side.

In step 730, the dApps analyze traffic metrics to send demand reports to a central arbitration application, which allocates PRBs among tenants in step 735. Specifically, in step 730, collected data is analyzed by tenant dApps to determine per-slice PRB demand forecasts and optimization approaches for the next scheduling interval, and a condensed PRB demand report may be sent to the central multi-tenant arbiter dApp (e.g., via an internal interface) in step 735. This may generally be periodically (e.g., every TTI), but other triggers may be appropriately configured. Note that the arbiter dApp may collect demand reports generally from all tenant dApps each scheduling interval.

Then, in step 740, metrics may be preprocessed and fed as input features to a multi-layer neural network model customized per tenant's traffic profile. Model outputs a forecast of physical resource block (PRB) demand for the next “N” TTIs for each network slice may be handled by the dApp. According to the techniques herein, the arbiter dApp then divides available PRBs between tenants for the next TTI. Updated PRB quotas are then sent to respective tenant dApps.

In step 745, the dApps then optimize resource distribution within each tenant's slices. That is, the tenant dApps optimize TTI-level PRB distribution amongst their slices based on the received quotas.

Procedure 700 may then end at step 750.

According to this particular implementation of the techniques herein, therefore, a system for flexible multi-tenant radio resource scheduling in O-RAN may comprise:
a plurality of distributed applications (dApps) executing on a shared O-DU, wherein one or more dApps is customized by each tenant operator to optimize resource demand for their respective network slices; and
a multi-tenant radio resource arbitration dApp executing on the shared O-DU that divides available radio resources between the tenant dApps by analyzing real-time demand data received from the tenant dApps and allocating configurable radio resource quotas to each tenant dApp periodically based on intelligent algorithm and traffic aware policies.

### Closing

In closing, the techniques herein introduce an advanced framework for dynamic, intelligent resource management in O-RAN networks. By integrating centralized intelligence with tenant-level customization, the system ensures efficient allocation of radio resources across diverse vertical services and multi-tenant environments. The approach leverages the RAN Intelligent Controller (RIC) for real-time decision-making and/or distributed applications (dApps) on the O-DU for tenant-specific optimizations.

As detailed above, the first specific implementation of the techniques herein centers on the RIC, which collects telemetry data and applies machine learning to optimize network slicing and numerology configurations. This ensures that resources align with the unique requirements of services like eMBB, mMTC, and URLLC. The second specific implementation herein emphasizes dApps running on the O-DU, enabling tenants to tailor resource allocation strategies to their specific needs while coordinating with a central arbitration application for PRB allocation.

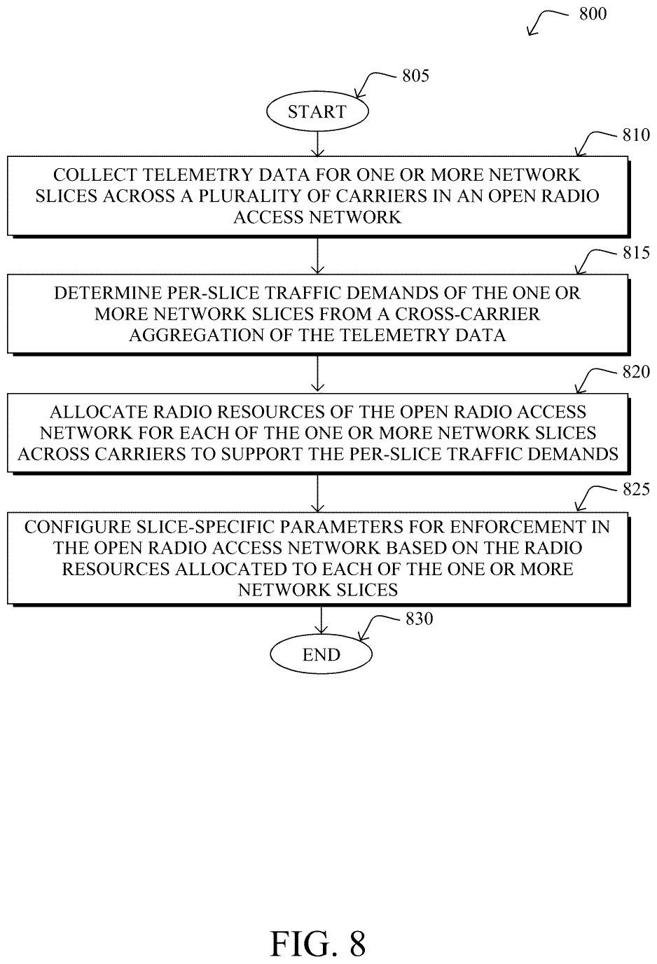

FIG. 8 illustrates an example simplified procedure (procedure 800) for dynamic resource allocation in O-RAN in accordance with one or more embodiments described herein, generally. For example, a non-generic, specifically configured device (e.g., device 200, an apparatus) may perform procedure 800 by executing stored instructions (e.g., process 248). The procedure 800 may start at step 805, and continues to step 810, where, as described in greater detail above, the process collects telemetry data for one or more network slices across a plurality of carriers in an open radio access network (O-RAN). In one embodiment, the telemetry data is selected from a group consisting of: buffer status, quality of service (QoS) metrics, traffic patterns, slice congestion, slice load status, and radio frequency (RF) conditions.

In step 815, the process determines per-slice traffic demands of the one or more network slices from a cross-carrier aggregation of the telemetry data. In one embodiment, determining per-slice traffic demands comprises: applying one or more machine learning algorithms to the cross-carrier aggregation of the telemetry data to model and forecast the per-slice traffic demands. In one embodiment, the per-slice traffic demands are based on one or more of: packet inter-arrival time distributions, traffic variability, traffic burstiness patterns, average data rates, peak data rates, latency requirements, reliability requirements, or mobility patterns. In one embodiment, determining per-slice traffic demands comprises: forecasting physical resource block (PRB) demand for a certain number of following time transmission intervals (TTIs).

In step 820, the process allocates radio resources of the open radio access network for each of the one or more network slices across carriers to support the per-slice traffic demands. In one embodiment, allocating comprises: computing optimized numerology allocations for each network slice of the one or more network slices, wherein the optimized numerology allocations support subcarrier spacings of the open radio access network. In one embodiment, allocating radio resources comprises: allocating physical resource block quotas for a following time transmission interval (TTI), wherein the slice-specific parameters are configured to optimize slice-specific resources based on the physical resource block quotas. In one embodiment, allocating radio resources further comprises: ensuring service level agreement (SLA) compliance for diverse service classes of the open radio access network.

In step 825, the process then configures slice-specific parameters for enforcement in the open radio access network based on the radio resources allocated to each of the one or more network slices. In one embodiment, the slice-specific parameters are selected from a group consisting of: media access control (MAC) scheduling, queue management, and access control configuration.

Procedure 800 may end at step 830. In one embodiment, the method further comprises: monitoring for updates to the per-slice traffic demands; and reallocating, in response to updates to the per-slice traffic demands, the radio resources for each of the one or more network slices across carriers to support the updates to the per-slice traffic demands.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

As described above, one specific implementation herein focuses on the use of the RAN Intelligent Controller (RIC) for real-time optimization of resource allocation, handling high-level decisions about resource allocation across the network. It relies on machine learning models to analyze telemetry data and determine the best configuration for network slices, dynamically adjusting parameters like numerology to meet the demands of different service classes. This is described in detail above in procedure 600 of FIG. 6. Another specific implementation herein, on the other hand, introduces the concept of distributed applications (dApps) running on the O-DU, as described in procedure 700 of FIG. 7. These dApps allow each tenant operator to customize their resource management strategies to fine-tune their slice configurations to align with specific traffic patterns, while a central arbitration application allocates physical resource blocks (PRBs) among tenants based on real-time demand. In general, the main difference between the two implementations lies in the control mechanisms: the first implementation uses centralized optimization through the RIC, while the second enables tenant-level customization through dApps on the O-DU.

In particular, in one embodiment, the process (procedure 800) is executed by a radio access network (RAN) intelligent controller (RIC), and wherein the telemetry data is collected from open radio access network central units (O-CUs) and open radio access network distributed units (O-DUs). In one embodiment, the process is specifically executed by an xApp component on the RIC.

In addition, in one embodiment, the process (procedure 800) further comprises: onboarding tenants to the open radio access network; and deploying a distributed application (dApp) for each of the tenants to collect the telemetry data. In one embodiment, the dApp for each of the tenants is hosted on a shared open radio access network distributed unit (O-DU) and deployed in a respective isolated virtual environment specific to each of the tenants. In one embodiment, the dApp for each of the tenants is configured to analyze traffic metrics and send the telemetry data as a demand report to a central arbiter dApp, and the method further comprises: aggregating, by the process as a central arbiter dApp, demand reports from each of the tenants; and allocating, as the radio resources, physical resource blocks (PRBs) of the open radio access network based on the demand reports. In one embodiment, the dApp for each of the tenants is deployed using a containerization technology.

Moreover, in some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: collecting telemetry data for one or more network slices across a plurality of carriers in an open radio access network; determining per-slice traffic demands of the one or more network slices from a cross-carrier aggregation of the telemetry data; allocating radio resources of the open radio access network for each of the one or more network slices across carriers to support the per-slice traffic demands; and configuring slice-specific parameters for enforcement in the open radio access network based on the radio resources allocated to each of the one or more network slices.

In still other implementations, a tangible, non-transitory, computer-readable medium storing program instructions that cause a device to execute a process comprising: collecting telemetry data for one or more network slices across a plurality of carriers in an open radio access network; determining per-slice traffic demands of the one or more network slices from a cross-carrier aggregation of the telemetry data; allocating radio resources of the open radio access network for each of the one or more network slices across carriers to support the per-slice traffic demands; and configuring slice-specific parameters for enforcement in the open radio access network based on the radio resources allocated to each of the one or more network slices.

The techniques described herein, therefore, provide a comprehensive solution to the challenges of resource allocation in shared O-RAN architectures. In particular, the techniques herein provide dynamic resource allocation and adaptation, enabling real-time, traffic-aware optimization of radio resources across network slices and tenants, ensuring the network can adapt to traffic variations and evolving service demands. Also, the techniques herein are scalable and flexible, supporting heterogeneous services and diverse tenant requirements, thus accommodating multi-tenant environments and a wide range of vertical use cases within a single shared O-RAN infrastructure. Moreover, enhanced SLA compliance and efficiency are provided herein, where intelligent scheduling and resource arbitration ensure slice isolation and alignment with QoS objectives, and the combination of centralized optimization and local customization ensures resources are allocated where they are most needed, maximizing efficiency. Furthermore, the techniques herein offer tenant-specific customizability, as customizable dApps allow tenants to tailor their resource management strategies to their unique traffic profiles, providing flexibility while maintaining centralized coordination. Lastly, by leveraging shared infrastructure instead of building parallel networks, the solution significantly reduces operational costs and minimizes the environmental impact of network deployments.

Illustratively, the techniques described herein may be performed by hardware, software, and/or firmware, (e.g., an “apparatus”) such as in accordance with the dynamic O-RAN resource allocation process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
collecting, by a process, telemetry data for one or more network slices across a plurality of carriers in an open radio access network;
determining, by the process, per-slice traffic demands of the one or more network slices from a cross-carrier aggregation of the telemetry data;
allocating, by the process, radio resources of the open radio access network for each of the one or more network slices across carriers to support the per-slice traffic demands; and
configuring, by the process, slice-specific parameters for enforcement in the open radio access network based on the radio resources allocated to each of the one or more network slices.

2. The method of claim 1, wherein the telemetry data is selected from a group consisting of: buffer status, quality of service (QoS) metrics, traffic patterns, slice congestion, slice load status, and radio frequency (RF) conditions.

3. The method of claim 1, wherein determining per-slice traffic demands comprises:
applying one or more machine learning algorithms to the cross-carrier aggregation of the telemetry data to model and forecast the per-slice traffic demands.

4. The method of claim 1, wherein the per-slice traffic demands are based on one or more of: packet inter-arrival time distributions, traffic variability, traffic burstiness patterns, average data rates, peak data rates, latency requirements, reliability requirements, or mobility patterns.

5. The method of claim 1, wherein allocating comprises:
computing optimized numerology allocations for each network slice of the one or more network slices, wherein the optimized numerology allocations support subcarrier spacings of the open radio access network.

6. The method of claim 1, wherein the slice-specific parameters are selected from a group consisting of: media access control (MAC) scheduling, queue management, and access control configuration.

7. The method of claim 1, wherein allocating radio resources further comprises:
ensuring service level agreement (SLA) compliance for diverse service classes of the open radio access network.

8. The method of claim 1, further comprising:
monitoring for updates to the per-slice traffic demands; and
reallocating, in response to updates to the per-slice traffic demands, the radio resources for each of the one or more network slices across carriers to support the updates to the per-slice traffic demands.

9. The method of claim 1, wherein the process is executed by a radio access network (RAN) intelligent controller (RIC), and wherein the telemetry data is collected from open radio access network central units (O-CUs) and open radio access network distributed units (O-DUs).

10. The method of claim 9, wherein the process is specifically executed by an xApp component on the RIC.

11. The method of claim 1, further comprising:
onboarding tenants to the open radio access network; and
deploying a distributed application (dApp) for each of the tenants to collect the telemetry data.

12. The method of claim 11, wherein the dApp for each of the tenants is hosted on a shared open radio access network distributed unit (O-DU) and deployed in a respective isolated virtual environment specific to each of the tenants.

13. The method of claim 11, wherein the dApp for each of the tenants is configured to analyze traffic metrics and send the telemetry data as a demand report to a central arbiter dApp, the method further comprising:
aggregating, by the process as a central arbiter dApp, demand reports from each of the tenants; and
allocating, as the radio resources, physical resource blocks (PRBs) of the open radio access network based on the demand reports.

14. The method of claim 11, wherein the dApp for each of the tenants is deployed using a containerization technology.

15. The method of claim 1, wherein determining per-slice traffic demands comprises:
forecasting physical resource block (PRB) demand for a certain number of following time transmission intervals (TTIs).

16. The method of claim 1, wherein allocating radio resources comprises:
allocating physical resource block quotas for a following time transmission interval (TTI), wherein the slice-specific parameters are configured to optimize slice-specific resources based on the physical resource block quotas.

17. An apparatus, comprising:
one or more network interfaces to communicate with a network;
a processor coupled to the one or more network interfaces and configured to execute one or more processes; and
a memory configured to store a process that is executable by the processor, the process comprising:
collecting telemetry data for one or more network slices across a plurality of carriers in an open radio access network;
determining per-slice traffic demands of the one or more network slices from a cross-carrier aggregation of the telemetry data;
allocating radio resources of the open radio access network for each of the one or more network slices across carriers to support the per-slice traffic demands; and
configuring slice-specific parameters for enforcement in the open radio access network based on the radio resources allocated to each of the one or more network slices.

18. The apparatus of claim 17, wherein the process is executed by a radio access network (RAN) intelligent controller (RIC), and wherein the telemetry data is collected from open radio access network central units (O-CUs) and open radio access network distributed units (O-DUs).

19. The apparatus of claim 17, wherein the process further comprises:
onboarding tenants to the open radio access network; and
deploying a distributed application (dApp) for each of the tenants to collect the telemetry data.

20. A tangible, non-transitory, computer-readable medium storing program instructions that cause a device to execute a process comprising:
collecting telemetry data for one or more network slices across a plurality of carriers in an open radio access network;
determining per-slice traffic demands of the one or more network slices from a cross-carrier aggregation of the telemetry data;
allocating radio resources of the open radio access network for each of the one or more network slices across carriers to support the per-slice traffic demands; and
configuring slice-specific parameters for enforcement in the open radio access network based on the radio resources allocated to each of the one or more network slices.
